(19) United States
(12) Patent Application Publication
(10) Pub. No.: US 2007/0112658 A1
(43) Pub. Date: May 17, 2007

(54) METHODS FOR NON-CASH EMPLOYEE COMPENSATION

(76) Inventor: Edward Joseph Dryden, Laredo, TX (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/559,862

(22) Filed: Nov. 14, 2006

Related U.S. Application Data
(60) Provisional application No. 60/736,816, filed on Nov. 14, 2005.

(51) Int. Cl. G06Q 40/00

(52) U.S. Cl. 705/35

(57) ABSTRACT

Disclosed herein are methods of non-cash employee compensation. An exemplary embodiment of a method of non-cash employee compensation may comprise a synthetic stock option program using a synthetic call. A synthetic call can be created without an actual call option by buying both the stock and a put option on the stock. A synthetic put may be created without an actual put option by selling the stock short and buying a call on the stock at the same price.

### CROSS-REFERENCE TO RELATED APPLICATION

This application claims priority to copending U.S. provisional application entitled, “System, Method and Process for Non-Cash Employee Compensation Program,” having Ser. No. 60/736,816, filed Nov. 14, 2005, which is entirely incorporated herein by reference.

### TECHNICAL FIELD

The present disclosure is generally related to financial investments and, more particularly, is related to methods for performing non-cash employee compensation programs.

### BACKGROUND

Conventional company stock option programs grant employees the right or option to purchase shares of an employing company or its publicly traded parent corporation at a fixed price, for a fixed term in the future, upon the condition of continued employment by the employing company and/or its publicly traded parent corporation and/or its subsidiaries. When traditional stock option programs result in a benefit to the employee, they may result in a dollar for dollar economic opportunity cost or economic opportunity loss to the company.

For example, referring to FIG. 1, employees 110A, 110B, 110C, and 110D are employed by company 100. If employee 110A receives a stock option 120 to buy ten thousand shares of his employer's publicly traded stock at a price of ten dollars per share, or a total cost of one hundred thousand dollars, and later exercised this option when the stock was trading at twenty dollars per share, the employee would receive an economic benefit of one hundred thousand dollars. However, the company would suffer an economic opportunity cost or loss of one hundred thousand dollars. This loss occurs because, if the ten thousand shares had sold at the then-market price of twenty dollars per share, the company would have received proceeds of two hundred thousand dollars instead of the one hundred thousand dollars that it received upon the exercise of the stock option. This one hundred thousand dollars in reduced proceeds for the shares issued is a real economic cost.

A real economic cost follows from the one hundred thousand dollar difference between the option exercise price and the market price on the ten thousand shares at the time of exercise. The one hundred thousand dollar difference is deductible as a business expense on the Federal Income Tax Return of the corporation. In spite of a deduction of one hundred thousand dollars on the Corporate Federal Tax Return, the one hundred thousand dollars is not reported as an expense on the net income statement of the corporation as published for the public stock holders and the general investing public at large. Instead, the income is overstated by the one hundred thousand dollars and the taxes owed in the income tax expense is overstated by the taxes that would be owed on the extra one hundred thousand dollars worth of income overstatement. After this overstatement is made in the net income statement, the taxes are reversed on the sources and uses of funds statement by stating that there is a “tax benefit of employee stock option program.”

The cumulative total of the legitimate tax deductions for below market value employee stock option exercises of many corporations exceeds the net income of these corporations before the deduction for stock option exercises.

Thus, if this deduction were reported on the net income statement used to compute the net income per share, these corporations would report a loss per share on their income statements. This would tend to depress the market price of their shares. This may create liability on the part of the corporation because security regulations exist forbidding both material misstatements and material omissions of true facts.

Other potential liabilities include financial statements prepared without conformity to and compliance with “generally accepted accounting principles” when the financial statements may violate the accounting principle of “matching” and the accounting principle of “materiality.” The accounting principle of “matching” requires that expenses be recognized in the same recording period that the revenues that these expenses produced are recognized. This principle may be violated because the revenues from the employees exercising stock options are recognized every recording period, but the expense of the stock options is not recognized. Therefore, there is no “matching” of expenses with the revenues that were reported.

The “materiality” accounting principle states that anytime an expense accrues to at least one percent of net income, it needs to be accounted for and recognized in the financial statements. These stock option expenses not only may exceed one percent of the net income, but they are sometimes over one hundred percent of the net income. However, they are generally not reported and not recognized in violation of the “materiality” principle of accounting.

Moreover, traditional stock option programs may not be tax efficient.

The sale to an employee of ten thousand shares for one hundred thousand dollars with a market value of those ten thousand shares is two hundred thousand dollars. This sale triggers a one hundred thousand dollar tax deduction for the employer and one hundred thousand dollars in ordinary income to the employee. This is tax inefficient because often the corporation has no taxable income due to the total of the deductions for stock option exercises being more that the total of the pretax income before the stock option exercises expense. Also, even if the corporation had one hundred thousand dollars of tax income prior to the option exercise, the option exercise reduces its taxes by thirty-five percent of the exercise, while the employee pays income taxes at the thirty-nine percent tax rate.

In practice, the tax inefficiencies are even greater. In order to keep its share count from increasing by ten thousand shares, the corporation takes the one hundred thousand dollars from the option exercise plus one hundred thousand dollars cash from earnings and uses the two hundred thousand dollars to buy back the ten thousand shares. However, although the corporation received a tax deduction for selling ten thousand shares for one hundred thousand dollars, it does not receive a tax deduction for buying back its shares for more than it sold them.

A corporation cannot generate a tax deduction from buying back its shares. Often, the amount of shares exercised in total by all employees is so large that a corporation does not have enough cash to buy back all the shares exercised on the same day that they are exercised. Often, months and years go by before there is cash to buy back the shares. If the shares increase in market value, the increased amount of cash spent on buying back the shares cannot be deducted from the income for federal income tax purposes.

If the corporation does not spend two hundred thousand dollars to buy back its shares, then the shares outstanding increases by ten thousand shares which reduces the growth in its earnings per share. Therefore, the corporation must make the choice between depleting the corporation's cash to repurchase shares and experiencing a low growth rate in earnings per share. In the traditional stock option program, an employee only benefits when the company's stock rises to a market price that is higher than the exercise price on the date that the option is granted. When a company's stock declines from the date of the grant to the date of the option expiration, the employee does not benefit. The employee also does not benefit when the stock price stays the same from the date of the stock option grant to the date of the stock option expiration. Thus, a heretofore unaddressed need exists in the industry to address the aforementioned deficiencies and inadequacies, among others.

### SUMMARY

Embodiments of the present disclosure provide methods for non-cash employee compensation. In this regard, one embodiment of such a method, among others, can be broadly summarized by the following: selecting features of a stock option program of a company; and granting an option through the stock option program to borrow shares of stock of the company.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a block diagram of a traditional stock option program.

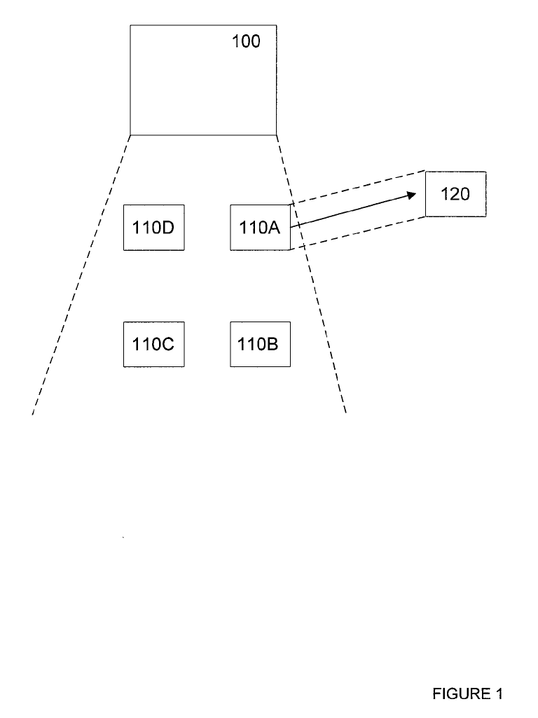

FIG. 2 is a block diagram of an exemplary embodiment of a method of non-cash employee compensation such as a synthetic option program.

FIG. 3 is a flow chart of the exemplary embodiment of a method of the non-cash employee compensation of FIG. 2.

FIG. 4 is a flow chart of the exemplary embodiment of a method of the non-cash employee compensation of FIG. 2.

FIG. 5 is a summary spreadsheet of a first exemplary embodiment of the method of non-cash employee compensation of FIG. 2.

FIG. 6 is a spreadsheet of stock dividends of the exemplary embodiment of a method of non-cash employee compensation summarized in FIG. 5.

FIG. 7 is a spreadsheet of a margin account of the exemplary embodiment of a method of non-cash employee compensation summarized in FIG. 5.

FIG. 8 is a spreadsheet of market prices of investments of the exemplary embodiment of the method of non-cash employee compensation summarized in FIG. 5.

FIG. 9 is a summary spreadsheet of a second exemplary embodiment of the method of non-cash employee compensation of FIG. 2.

FIG. 10 is a spreadsheet of a margin account of the exemplary embodiment of the method of non-cash employee compensation summarized in FIG. 9.

FIG. 11 is a spreadsheet of market prices of investments of the exemplary embodiment of the method of non-cash employee compensation summarized in FIG. 9.

FIG. 12 is a summary spreadsheet of a third exemplary embodiment of the method of non-cash employee compensation of FIG. 2.

FIG. 13 is a spreadsheet of stock dividends of the exemplary embodiment of the method of non-cash employee compensation summarized in FIG. 12.

FIG. 14 is a spreadsheet of the financial position of the company implementing the exemplary embodiment of the method of non-cash employee compensation summarized in FIG. 12.

FIG. 15 is a spreadsheet of market prices of investments of the exemplary embodiment of the method of non-cash employee compensation summarized in FIG. 12.

### DETAILED DESCRIPTION

Methods of non-cash employee compensation are disclosed herein, which provide a lower economic opportunity cost and a tax efficient manner for recruiting and retaining desirable key employees, managers, salesmen, and executives. An exemplary embodiment of a method of non-cash employee compensation may comprise a synthetic stock option program using a synthetic call. A synthetic call can be created without an actual call option by buying both the stock and a put option on the stock. A real call provides the profit appreciation from a rise in the stock price without risk of capital loss from owning the stock. A synthetic put may be created without an actual put option by selling the stock short and buying a call on the stock at the same price. A real put provides the profit from a decline in the stock without the risk of selling the stock short.

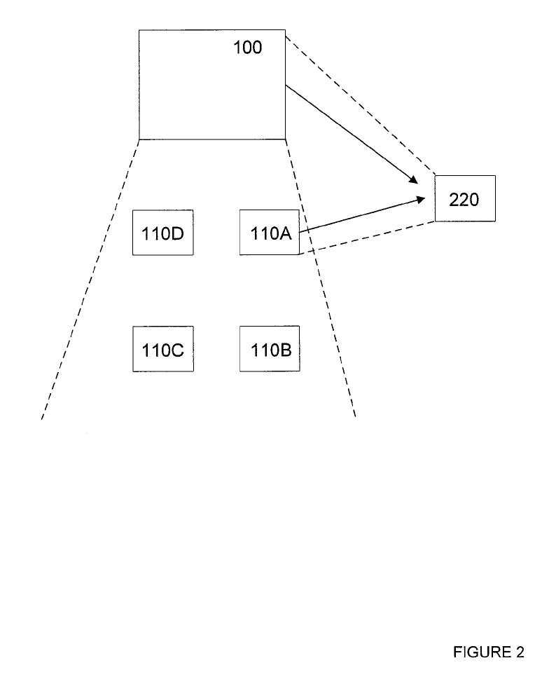

Referring to FIG. 2, stock option 220 under a synthetic stock option program gives employee 110B a benefit of having investment capital working for years or decades versus saving up the capital by spending less money than annual cash compensation. It does this not by optioning company stock, but by lending company stock that is paid back in the exact same number of company shares loaned rather than in money. Using an example of a Microsoft employee getting an employee stock option of $500,000 of Microsoft stock, the following differences exist between a traditional or conventional employee stock option program and a synthetic employee stock option program.

Traditional Program: Microsoft stock is selling at $50 a share and the employee gets a $500,000 employee stock option by getting options on 10,000 Microsoft shares at a price of $50 per share. Five years later the stock options grants have “matured” or are “exercisable” and the stock is selling at $200 per share. The employee exercises the option on 10,000 shares by buying 10,000 shares from Microsoft pursuant to the options exercise. These shares have a market value of $2,000,000 and thus the employee has a profit of one and one half million dollars on the exercise. The employee has taxable ordinary income on the date of exercise of $1,500,000, which is the amount of the exercise profit on date of exercise.

Microsoft has a $1,500,000 ordinary business expense on its corporate income tax return for employee compensation. Microsoft reports no employee compensation from this option grant and exercise on its annual report to shareholders because, based on Accounting Standards Board Opinion No. 125 (APB 125), the grant was at 100% of market price on date of grant, giving rise to no employee compensation expense. Under APB 125, when stock options are granted at 100% of the market price on date of grant, they represented no expense on the date of the grant or at anytime thereafter.

Financial Accounting Standards Board Regulation No. 123 (FASB 123) imposes some small employee compensation expense because, even without any money value, the grants have some “time value” on date of grant. Under FASB 123, stock options granted at 100% of market price do represent an expense because they have “time value” which can be calculated by the Black-Scholes model or other models of predicting the market value of stock options. Although APB 125 and FASB 123 focus on date of grant, both the economic costs of dilution and the taxable income and expense is entirely dependent on the date of exercise.

APB 125 denies that there is a cost and FASB 123 underestimates the cost because FASB 123 focuses on the date of the grant, while 100% of the cost is determined by the market price on the date of the exercise. Compliance with FASB 123 and APB 125 allows auditors to claim that the financial statements were prepared and are presented “in conformity with generally accepted accounting principles” even though they do not comply with the “matching” and “materiality” principles.

Synthetic Program: Microsoft stock is selling at $50 a share and the employee gets a loan from Microsoft of $500,000 worth of Microsoft stock by having Microsoft transfer into his name 10,000 shares of its stock and making a notation on its employee bookkeeping records that the employee owes the company 10,000 shares of its stock. The employee deposits his 10,000 shares of Microsoft stock (which are registered in his name) in a margin account that is used to implement the synthetic program and uses the 10,000 shares to purchase an additional 10,000 Microsoft shares so that the employee is holding 20,000 shares in his margin account. The employee owes the stockbrokerage firm $500,000 for the money that he borrowed to buy the 10,000 shares that he bought, not the shares that the company loaned to him.

Five years later the stock is at $200 and $25,000 of margin interest (interest at 10% which is high for what is typically charged) has accumulated. The margin account has a debit of $525,000 ($500,000 initial borrowing plus $25,000 of interest) but holds 20,000 shares worth $4,000,000. The employee then withdraws 10,000 shares from the margin account. He transfers and delivers these shares to Microsoft, repaying the loan of 10,000 shares from the company. His margin account now holds 10,000 shares (all his) worth $2,000,000 and a debit balance of $525,000 for a net equity of $1,475,000. The tax consequence is now different. The employee incurs no taxable income from withdrawing 10,000 shares from his margin account and then transferring the shares back to Microsoft in repayment of the 10,000 share loan that he originally got from the company. The company gets no tax deduction from the loan of the 10,000 shares nor does it have taxable income from the repayment of the shares. If the employee failed to repay the shares then the company would have a bad debt expense or, possibly, an employee compensation expense and the employee would have taxable income for the forgiveness of debt.

Tax Differences: The synthetic program is more tax efficient in that, for example, in the typical employee stock option program the employee is taxed at 39% marginal tax rate and the corporation deducts the money from the exercise at the 35% corporate tax rate. Also, sometimes corporations do not have enough taxable income to deduct the option program costs so that the deduction is lost to the corporation.

There are no major tax consequences with the synthetic option program. A loan of stock is not a taxable event to the corporation nor to the employee. The repayment of the shares is not taxable income to the corporation, nor is it a tax deduction or taxable income to the employee. The employee incurs no taxable income on the appreciation of the 10,000 shares purchased in the open market as long as he continues to hold them and does not sell them. When he sells them, he then incurs capital gains taxes at a lower rate than ordinary income. The interest expense on the margin account is a tax expense to the employee regardless of any appreciation of the shares. An accrual basis taxpayer would deduct these interest charges in the tax year they are incurred, and a cash basis taxpayer would deduct the interest charges in the tax year they are paid.

Economic Difference: Because the loan of company shares and the pledging in a stockbrokerage margin account does not force the buying power created by the deposit of the original loan shares to be used to buy more of the same kind of shares, with the synthetic program, a loan of International Bank of Commerce shares which have been going sideways for several years could be used by a bank employee to purchase Google shares which have not been going sideways for several years. With the traditional program the value of the option grants is wholly dependent on the performance of the stock that is optioned. With the synthetic program the value of the loaned stock is not dependent on the performance of the loaned stock, but on the performance of the purchased stock. Another economic difference for a stock that performs like Google is that the optioning of Google shares to Google employees results in tremendous dilution costs to the shareholders of Google, while the loan of Google shares, the using of the loaned shares to buy other shares, and the repayment of the loaned shares to Google causes no dilution costs to the Google shareholders.

Accounting Difference: The synthetic program, by writing off stock loaned and not repaid by employee, complies with generally accounting principles while a traditional program under FASB 123 violates two accounting principles, the principle of “matching” and the principle of “materiality”.

Abuse Potential Difference: The synthetic program is not susceptible to back dating abuses because its economic benefits come from the third party open market transactions of buying other shares with the margin account, buying power generated by the loaned shares and not by the date of the loan. With the conventional program everything turns on the date of grant, a wholly internal record keeping matter.

Exemplary embodiments of the disclosed methods of non-cash employee compensation include actions by an employer with publicly tradable stock or an employer that is owned in whole or in part by a parent corporation with publicly tradable stock. Exemplary embodiments of the disclosed methods of non-cash employee compensation include actions by or for a present or prospective employee, manager, executive, and/or corporate officer of the employer that the corporate employer currently employs and wants to retain or recruit. Exemplary embodiments of the disclosed methods of non-cash employee compensation include actions by or for a third party trustee or escrow agent whose role is to secure the repayment of loan stock without placing any limitation on its sale or on its hypothecation (pledging as collateral or security to secure borrowing of money or other shares) or to act as co-owners in record title of real estate such as an employee's home or real estate investment.

Exemplary embodiments of the disclosed methods of non-cash employee compensation may include a program agreement or contract entered into by the employer, the employee, and the trustee or escrow agent or, alternatively, just the employer and employee. Exemplary embodiments of the disclosed methods of non-cash employee compensation may include a loan of registered and freely tradable company stock that is repayable in the same number of shares of company stock adjusted for stock splits and stock dividends during the term of the loan. Cash dividends may be paid on the loan shares during the term of the program in cash rather than in stock.

Exemplary embodiments of the disclosed methods of non-cash employee compensation may include security firms or stock brokers who are insured by the Securities Investors Protection Corporation (SIPC) and by private insurance or surety companies for amounts in excess of the coverage from the SIPC, and whose accounts are accessible for both inquiries and trading through the Internet. Exemplary embodiments may also include securities firms whose accounts are accessible for both inquiries and trading via phone and in person. Exemplary embodiments may also include a password that can be used to enter trades into a computer system of a securities firm or stockbroker.

Exemplary embodiments of the disclosed methods of non-cash employee compensation may include firms that act as a registrar for the stock or shares of publicly traded corporations. Exemplary embodiments of the methods of non-cash employee compensation may include firms that act as a transfer agent for the stock or shares of publicly traded corporations.

Exemplary embodiments may include firms that act as employee lessors (employee leasing businesses), contract staffing, or employee recruiters for other businesses including, but not limited to, healthcare providers or hospitals, who, due to being owned by a governmental subdivision, such as a county, city, or state, or by religious, non-profit, or foundation are owned by an employer with no publicly tradable stock or shares.

Exemplary embodiments of the disclosed methods of non-cash employee compensation may include real estate brokerage firms, escrow and title companies that can close real estate transactions, real estate mortgage brokers or bankers that can finance real estate purchases, private mortgage insurance companies, and real estate appraisers that are qualified and licensed to appraise real estate, and sellers of real estate that own an interest money contract that is suitable for the purchase and sale of real estate through an escrow and title company. Exemplary embodiments of the disclosed methods of non-cash employee compensation may include commodities or future contracts brokers. Exemplary embodiments of the disclosed methods of non-cash employee compensation may include margin accounts or cash accounts agreements entered into by security firms and the employee or agent of the employee.

Exemplary embodiments of the disclosed methods of non-cash employee compensation may include margin accounts (a securities account in which the securities firm is willing to loan money or shares subject to the margin regulation of the Federal Reserve) at a securities or stock brokerage firm. Exemplary embodiments of the disclosed methods of non-cash employee compensation may include cash accounts (a securities account where the securities firm is not willing to loan money and/or shares subject to the margin regulation of the Federal Reserve) at a securities or stock brokerage firm.

Exemplary embodiments of the disclosed methods of non-cash employee compensation may include the Internet, computer systems and computer programs owned and operated by the employer, computer systems and computer program owned an operated by the program trustee or escrow agent, computer systems and computer programs owned and operated by the securities firms or stock brokerage firms, and computer systems and computer programs owned or used in phone and phone systems operated by the employee, manager, executive, or corporate office participating in the program. Exemplary embodiments of the disclosed methods of non-cash employee compensation may employ the national and international telephone systems, the postal services of the United States and other countries, various securities exchanges and over-the-counter stock markets where publicly traded stocks and real estate investment trusts can be bought or sold through stock brokers, options, exchanges, commodities, and future contracts or exchanges.

Exemplary embodiments of methods for non-cash employee compensation may be used, for example, to recruit or retain employees or to compensate its present employees. The employer may select present, future, and prospective employees to whom it wishes to offer the non-cash employee compensation and selects features of the program that it wants to offer. Once the features are selected, the employer may contract with a third party trustee or escrow agent that is willing to participate in the program. Trust departments of banks and security firms that offer custodial or administrative services for 401k programs or corporation pension funds may be among the existing businesses that may serve as trustee pursuant to a negotiated and agreed to fee schedule.

If the employer desires to include home ownership investment or other real estate investment other than publicly traded real estate investment trusts, the employer may find, and contract with, third parties for the administration of the ownership of real estate in a manner that secures the corporation's loan of its shares to the employee, manager, executive, or corporate officer pursuant to the disclosed methods for non-cash employee compensation.

The fee schedule of the third party trustee may have charges that are based on assets in the program and on the type, kind, and number of transactions that may close within the program. Exemplary embodiments may be implemented without a trustee or escrow agent. However, this exposes an employer to a “morals” risk if the employee breaches the agreement and steals the funds and/or securities that he or she is not entitled to receive without repaying the loan of company shares. This “morals” risk may be mitigated with margin accounts or cash accounts that are used in the program opened in the joint name of both the employee and the trustee or escrow agent.

The primary address on the account may be the trustee or escrow agent instead of the employee. The mailing of checks for funds or shares of securities may be jointly made out to both the program trustee or escrow agent and the employee, and would be mailed to the physical mailing address of the trustee or escrow agent. The trustee or escrow agent may then endorse the check or stock certificates for the employee and mail those endorsed instruments to the physical mailing address of the employee for the transfer or negotiation of the funds or securities into the employee's name.

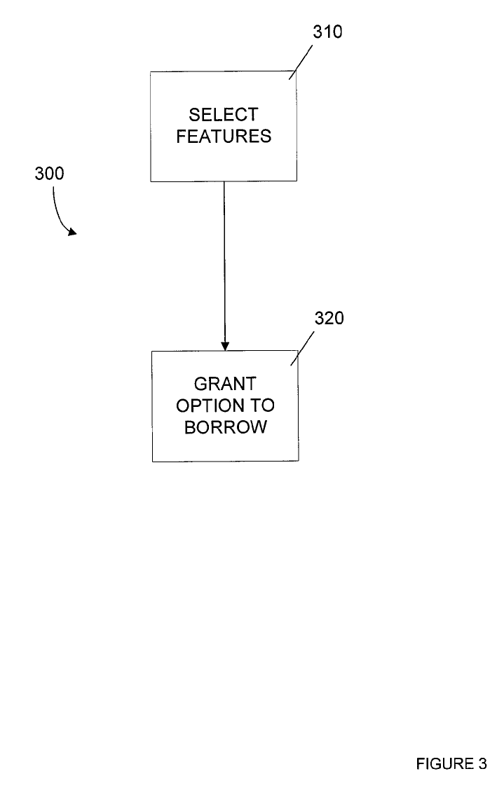

Referring to flow chart 300 of FIG. 3, in block 310, the employer first selects the overall features of the synthetic option program. After an employer has selected the overall features of this non-cash employee compensation program, in block 320, the employer grants a stock option under the synthetic option program which loans shares of the employer's stock to the employee.

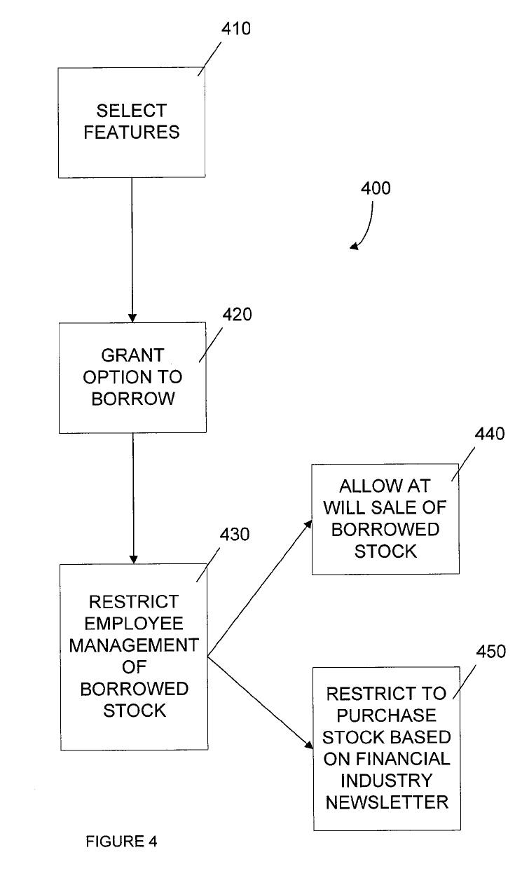

Referring to FIG. 4, an exemplary embodiment of a method of non-cash employee compensation is presented in flow chart 400. In block 410, the employer first selects the overall features of the synthetic option program. After an employer has selected the overall features of this non-cash employee compensation program, in block 420, the employer grants a stock option under the synthetic option program which loans shares of the employer's stock to the employee. In block 430, the employer may exempt particular employees or a group of employees from any of the program features. Exemplary embodiments of systems and methods of non-cash employee compensation may include block 440 in which the employer permits the voluntary, at-will, outright sale of the stock loaned to the employee by the employer without the triggering occasion of a margin call sale of the stock by the margin account carrying securities firm or stock broker. One advantage to the employee of being able to permit an at-will (no margin call) sale is that the employee can thereafter invest a larger amount in the investment program of his choice than what would be available if the stock could only be pledged within the margin account and only the borrowed funds invested according to the investment vehicles, instruments, or assets that are allowed by the program, and can, therefore, be made by the employee within the program.

An at-will sale of the loaned employer's stock during the program's term enables the stock to be repurchased at the end of the program or during its term for a price less than the price that it was sold in the event that the stock were to decline in market price. This may enhance the benefit of the program to the employee by the decline in the market price. In a traditional stock option program, a stock that declines below the market price at the time of the stock option grant, which is below its option exercise price, produces no benefit to the employee.

Another embodiment of the disclosed methods of non-cash employee compensation may include block 450 in which the employee may operate the margin account on his own by purchasing and selling securities or binding the employee to the recommendation of private or public investment newsletters.

Disadvantages of not restricting an employee's choices include honest mistakes by the employee in selecting investments and in the timing of buying them, holding them, and selling them. He may lose money during the entire length of the program, causing the corporation to incur a bad debt expense equal to the value of the loaned shares of stock that are not repaid and returned to the employer. Another disadvantage includes a distraction of the employee from the work or job that the employee is supposed to perform for the employing corporation due to hands-on management of an employee's margin or cash account.

Once an employer has chosen features for its particular implementation of the methods of non-cash employee compensation and the employer has secured a suitable and willing third party trustee, the employee and the third party trustee jointly open a margin and/or cash account at a suitable securities firm and/or stock broker. The securities firm and/or stockbroker may or may not be Internet enabled. The employer then uses its registrar and stock transfer agent to deposit the number of shares it has agreed to loan to the employee pursuant to the program into the stock brokerage account. As far as the stock brokerage firm is concerned, these shares are unencumbered and can be freely traded or used as collateral in a margin account for the purpose of borrowing cash or other shares.

In the event that the program permits use of the loan shares to buy a home (for example, a real estate investment to assist the employee to move to the area of the employer's location), the employee and a third party trustee contract a real estate agent to locate a suitable and acceptable home and make arrangements with the owner to enter into an earnest money contract. They also deposit the executed earnest money contract, together with the earnest money, with the real estate escrow and title company. If the earnest money is substantial, the employee and third party trustee may direct the stock broker to remit a sum to their joint names and deposit the sum in the escrow account that has been opened at the escrow and title company.

In the same fashion and manner, a down payment or equity for purpose of the mortgage can be transferred from the securities broker to the third party trustee and employee and jointly, by them, to the escrow and title company. The third party trustee and employee then make arrangements with the real estate mortgage broker and/or banker to finance a portion of the home purchase price. If this financing requires private and/or public mortgage insurance, an appropriate firm may be contacted.

Next, the employee and third party trustee, both of whom have a password for the cash and/or margin stock brokerage account, operate the accounts in the agreed manner according to the program's guidelines and features. A third party trustee may have a computer program to access and monitor the stock brokerage accounts in order to assure compliance with the program regulations, requirements, and limitations. The employee may use the Internet and appropriate Internet software such as a browser to monitor and manage (enter purchase and sale orders) the stock brokerage accounts within the parameters of the particular features, regulations, and restrictions of its employer's program.

A newsletter may be used in the program to provide investment direction. If a newsletter is used in the program, the employee and the third party trustee may make arrangements to receive this newsletter via email or the postal service. If future contracts, managed future accounts, hedge funds, and/or mutual funds are used by the program, they are used in the same way and manner as are the cash and margin accounts as mentioned above.

At the end or termination in time of the program, assets are sold to free up the employer's loan share. If these shares have been previously sold under the provision of the program, then they are repurchased free and clear with the above liquidations. Once the number of previously loaned shares are in the account and the account's debit balance has been reduced to the level necessary to transfer out the shares, the shares are transferred by the stock broker to the physical or electronic address of the third party trustee. The employer's interest in the shares is conveyed and assigned to the employer or to the third party trustee for the benefit of the employer. Once an employer has received all of the previously loaned shares, the third party trustee may assign its interest in all the cash, margin, future accounts, or real estate to the employee.

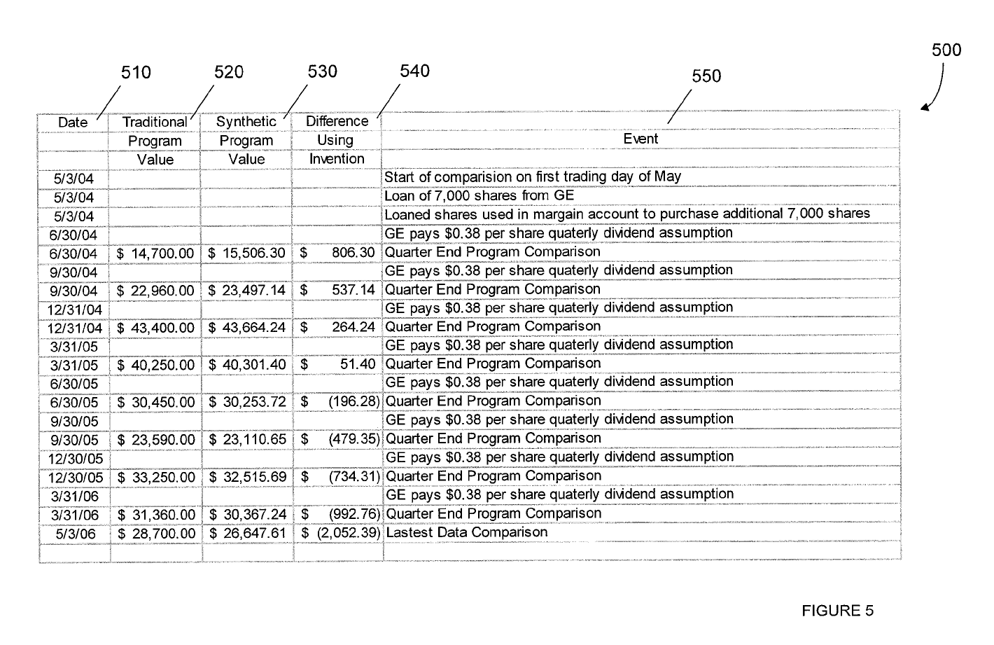

By way of an example, The General Electric Company (GE) and an employee of GE may implement a method of non-cash employee compensation subject to an employment contract. In a first example, the employee has been employed by GE and had been loaned seven thousand shares of the company's stock on May 3, 2004. The employee has been restricted to implement the program by using his seven thousand loaned shares of GE stock to purchase another seven thousand shares in his program's margin account. In this case, the results are as set forth in FIGS. 5-8.

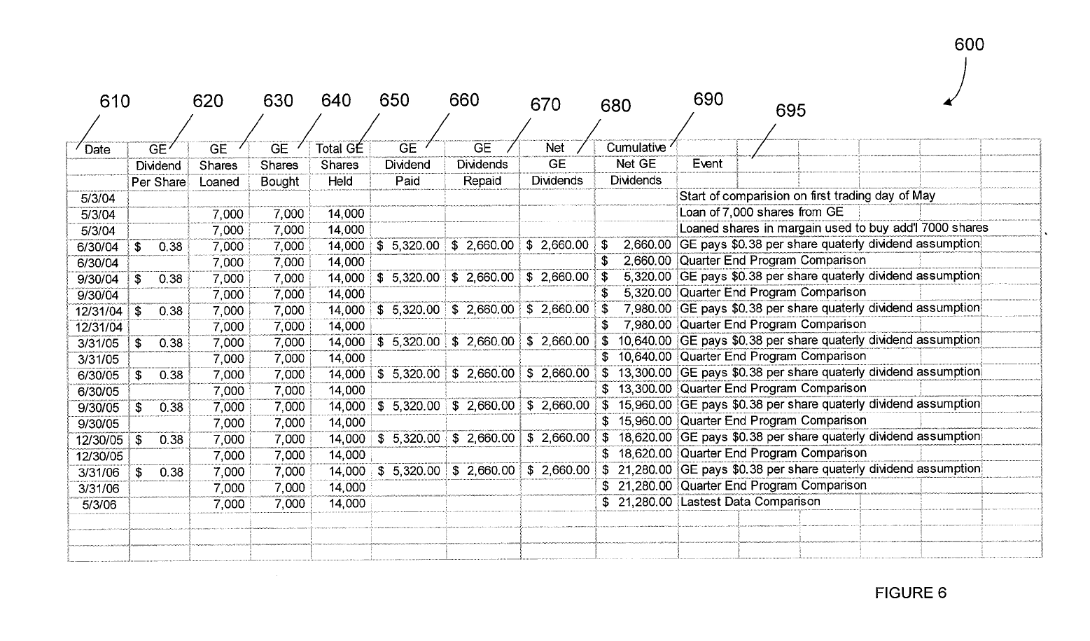

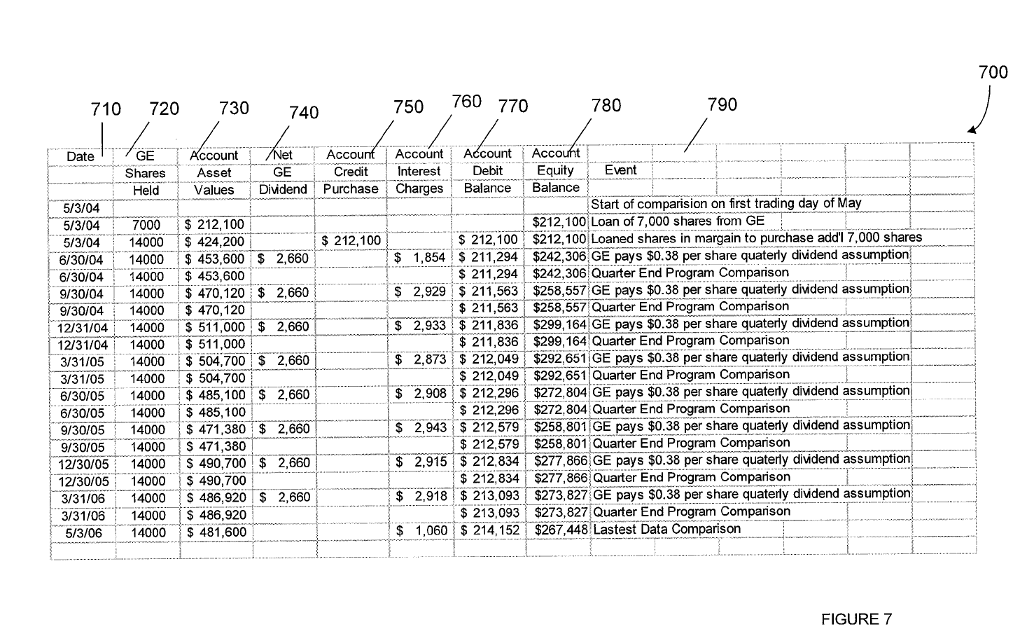

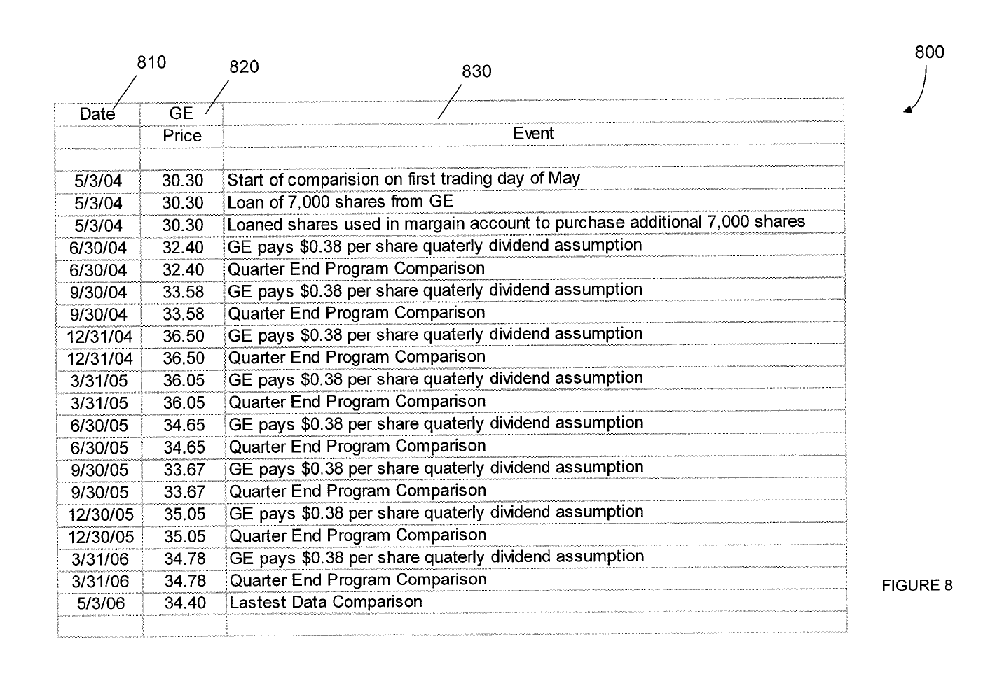

Regarding FIG. 5, spreadsheet 500 provides an example of a loan of 7,000 GE shares deposited in a margin account to buy another 7,000 shares of GE in the open market from third party sellers of GE shares. Spreadsheet 500 provides the end result of this restricted example of a method for non-cash employee compensation (restricted by limiting the employee to the purchase of GE shares rather than allowing him to make other investments). Spreadsheet 500 incorporates the results of data shown in spreadsheet 600 of FIG. 6, spreadsheet 700 of FIG. 7, and spreadsheet 800 of FIG. 8.

Since, in this example, lending of GE shares and the purchase of GE shares with the margin account are enabled by the deposit of the loaned shares in the margin account, dividends would be paid by GE on both the loaned shares and the GE shares purchased from third parties. Therefore the amount of GE dividends may be tracked.

Column 510 of FIG. 5 shows dates for events of column 550. Column 520 (“Traditional Program Value”) of FIG. 5 shows the value of a traditional employee stock option program with an option granted on 7,000 shares at the price of $30.30, the market price on May 3, 2004, which is shown in column 820 of FIG. 8. Column 530 of FIG. 5, entitled “Synthetic Program Value,” shows the value of the synthetic program shares on the various dates shown in column 510. Column 540 of FIG. 5 entitled “Difference Using Invention” shows the difference between the value of a traditional stock option program to the employee and of a synthetic option program on the dates listed in Column 510.

Although the synthetic option program is valued at only $26,647.61 on May 3, 2006, two years after the start of the program, it is not inferior because the traditional option program would cost GE $28,700.00 in stock dilution costs, while the synthetic option program would cost GE less than $100 in cash (due to trustee fees). Additionally, the traditional program would create taxable income for the employee subject to the alternative minimum tax on taxable income of $28,700.00.

Referring now to FIG. 6, spreadsheet 600 tracks and calculates the amount and consequences of GE dividends historically paid in the calendar quarters shown. Column 610 contains a date for an event of column 695. Column 620 is the GE dividend per share granted on a date of column 610. Column 630 represents shares of GE stock that are loaned to the employee. Column 640 represents the additional shares of GE stock that are purchased on margin based on the borrowed shares of GE stock in column 630. Column 650 represents the total number of GE shares owned on the date in column 610.

Column 660 represents the dividends paid on the total amount of GE shares held in column 650. The dividends received are on both the loaned shares and the purchased shares; however, the dividends on the loaned shares are owed and have to be repaid to GE because they are on loaned shares and not on owned shares. The employee owes the company the dividends in column 670 for the shares in column 630 that were loaned to the employee.

Column 680 represents the remaining dividend amount after the dividend on the loaned shares has been repaid. Column 690 tracks the cumulative provides the amount of dividends paid by GE on the cumulative amount of net dividends provided in column 680. The dividends received are on both the loaned shares and the purchased shares; however, the dividends on the loaned shares are owed and have to be repaid to GE because they are on loaned shares and not on owned shares.

Referring now to FIG. 7, spreadsheet 700 tracks the effect of the dividends received during the various quarters listed in column 710 and labeled in column 790. Column 720 tracks the number of shares held on the date provided in column 710. Column 730 tracks the value of the shares held in column 720 using the share price presented in column 820 of FIG. 8. Column 740 provides the net dividend from column 680 of FIG. 6. Column 750 presents the credit purchase of 7000 shares. Spreadsheet 700 also tracks the amount of interest charged by the margin account carrying stockbroker in column 760. The amount of money loaned on the “buying power” is calculated in column 770. This may also be referred to as “SMA” generated or caused by the deposit of the 7,000 shares loaned by GE and is equal to the net worth or value of the “equity” in the margin account. This “equity” is the equity on the books of the carrying stock brokerage firm, but is not the true equity or value of the program to the employee. That value is the amount shown on column 530 of FIG. 5. The equity balance of the account is provided in column 780.

Referring now to FIG. 8, column 820 of spreadsheet 800 shows the price of GE stock on the dates set out in column 810. The dates of column 810 correspond to particular events of column 830, such as quarterly dividend assumption.

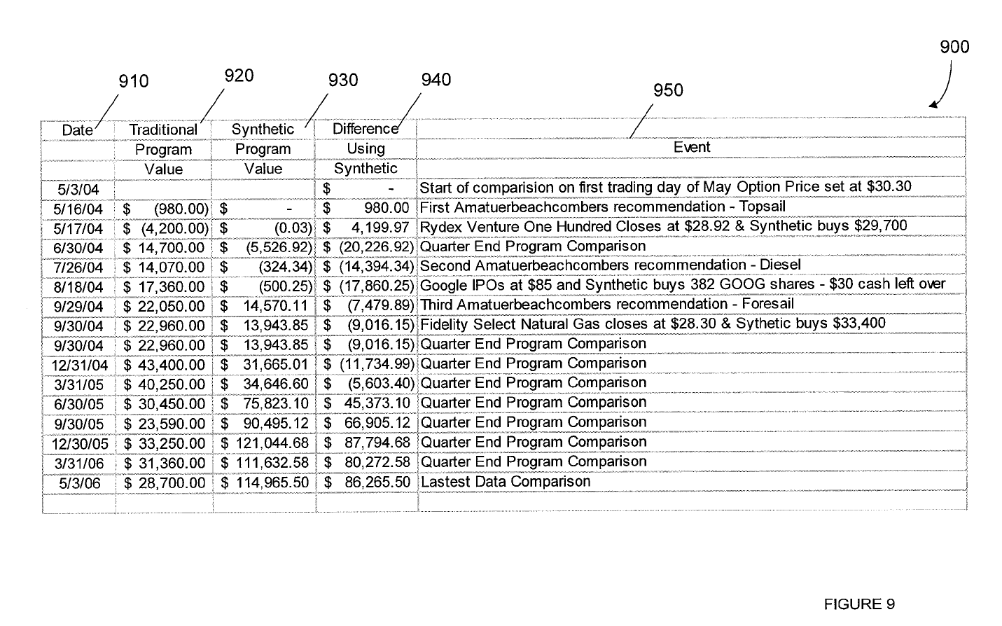

In a second example, an employee has been employed by GE and has been loaned seven thousand shares of the company's stock on May 3, 2004. In this example, the employee has been restricted to using his seven thousand loaned shares of GE to purchase stock in a margin account at the recommendations of the AmateurBeachComber's newsletter. Any financial industry recommendations could be used alternatively. An overview of the financial ramifications are set out in FIGS. 9-11.

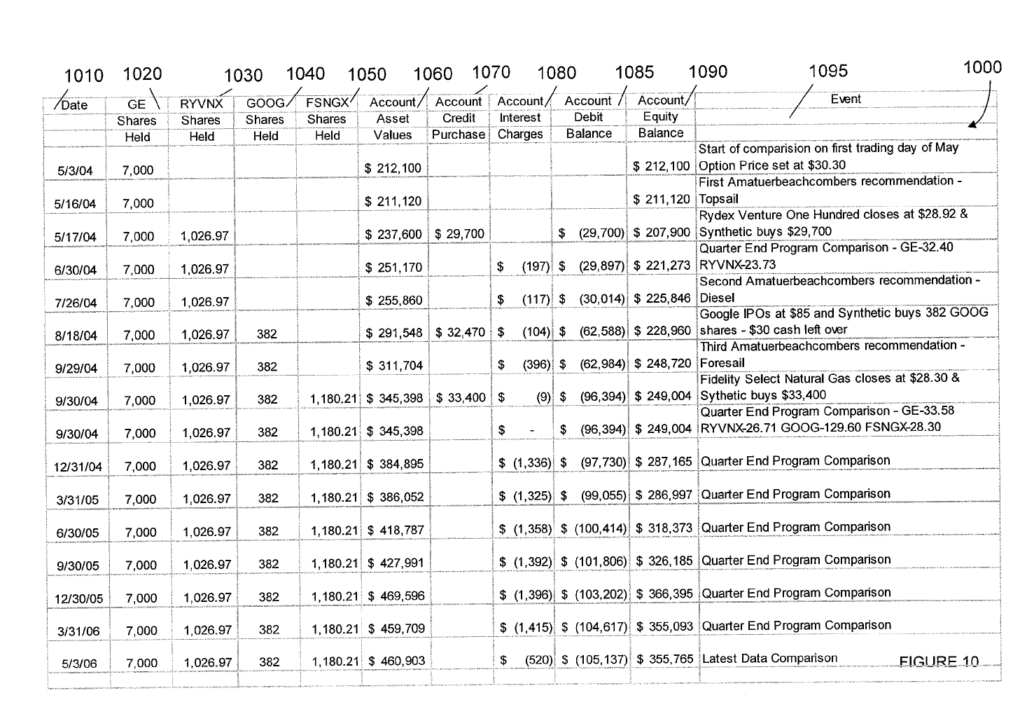

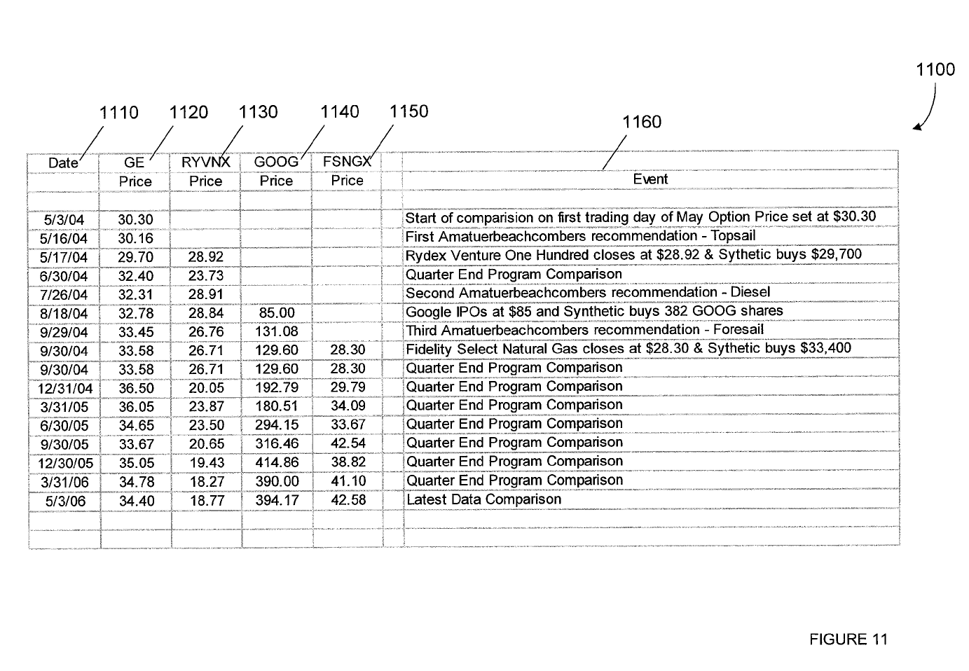

Referring to FIG. 9, spreadsheet 900 uses the example of a loan of 7,000 GE shares deposited in a margin account to buy investments that were the investments recommended by an exemplary newsletter, a non-limiting example of which is “Amateurbeachcombers.” The newsletter includes recommended dates and recommended prices. Spreadsheet 900 shows the end result of this exemplary implementation of a synthetic option program. Spreadsheet 900 incorporates the results of data shown on spreadsheet 1000 of FIG. 10 and spreadsheet 1100 of FIG. 11.

Since the exemplary synthetic option program uses the lending of GE shares and the purchase of other investments (in this example the other investments are two mutual funds, The Rydex Venture One Hundred, symbol “RYVNX” and Fidelity Select Natural Gas Fund, symbol “FSNGX” and Google, symbol “GOOG”) with the margin account “buying power” created or generated by the deposit of the loaned shares in the margin account. For simplicity, this example only shows the use of the buying power generated by 3,000 of the 7,000 GE shares deposited in the margin account, while it compares with the entire 7,000 shares being used in the traditional stock option program.

Column 920 of spreadsheet 900 shows the value of a traditional employee stock option program with the option granted on 7,000 shares at the price of $30.30, the market price on May 3, 2004, as shown in column 1120 of FIG. 11. Column 930 of spreadsheet 900, entitled “Synthetic Program Value,” shows the value of the synthetic option program on the various dates shown in Column 910. Column 940 of spreadsheet 900, entitled “Difference Using Synthetic,” shows the difference to the employee between the value of a traditional stock option program and of the synthetic option program on the dates listed in column 910.

The synthetic option program, valued at $114,965.50 on May 3, 2006, two years after the start of the program, is clearly superior although is only using three sevenths of the capital of the traditional employee stock option program. Additionally, the traditional program would cost GE $28,700.00 in stock dilution costs while the synthetic program would cost GE less than $100 in trustee fees. Also, the traditional program would create taxable income subject to the alternative minimum tax on taxable income of $28,700.00 to the employee. Column 940 of spreadsheet 900 shows the difference in value to the employee on the various dates shown in column 910. Traditional employee stock option programs may involve option grants with option periods of five to seven years.

Referring to FIG. 10, spreadsheet 1000 tracks and calculates the amount of value of the “equity” in the margin account. This “equity” is the equity on the books of the carrying stock brokerage firm, but is not the true equity or value of the program to the employee. The value to the employee is provided in column 930 of spreadsheet 900 (FIG. 9). Column 1010 sets out the date that the data in a particular row is associated with historically. Column 1020 reflects the deposit of 7,000 shares of GE, which represent the 7,000 shares loaned by GE to the employee in the synthetic option program.

Column 1030 reflects the amount of shares of the Rydex Venture 100 Fund (funds allow for fractional share purchases) whose symbol is “RYVNX” and which was the recommendation of the Amateurbeachcombers newsletter for an exemplary model portfolio. The Amateurbeachcombers newsletter is preferably implemented with a combination of seven model portfolios with one seventh of the capital invested in each of the model portfolios at the start.

Column 1040 represents the purchase of Google shares with the buying power generated by 1,000 GE loaned shares based on the recommendation of an exemplary model portfolio. Since this recommendation was for a particular stock, and since stocks cannot be purchased in fractional common shares, there was $30 cash left over as is set out in column 1095 in the entry for Aug. 18, 2004.

Column 1050 represents a purchase with the buying power generated by 1,000 GE loaned shares based on the recommendation of an exemplary model portfolio. In a non-limiting example, this recommendation was for a mutual fund, the Fidelity Select mutual fund Fidelity Select Natural Gas Fund (Symbol FSNGX). Column 1060 represents the market value of all the securities in the margin account for various dates as set out in column 1010. This is the value of the GE shares loaned, the value of Rydex Fund shares, the value of the Google shares in the margin account, plus the value of the Fidelity Select fund.

Column 1070 sets out the amounts borrowed from the stockbrokerage firm to carry the margin account on the various dates that the exemplary model portfolios recommendations are implemented. This amount is determined to be the value of 1,000 shares of GE on that date. Column 1080 sets out the amount of interest charged by the stockbrokerage firm for the credit advances during the time interval from the date of a previous row to the date of the particular row. Column 1085 represents the total of the original loan advances by the broker and the carry costs or interest charges charged by the broker on the debit balance of the margin account. Column 1090 represents the equity shown on the books of the stockbroker for the margin account on each date of column 1010. Because this “equity” is the equity in the margin account and counts the value of the 7,000 GE shares loaned under the invention as “equity,” it is not the value to the employee. The value to the employee is set out in column 930 of spreadsheet 900 of FIG. 9. Column 1095 sets out the explanation of the event for each date of column 1010.

Referring to FIG. 11, spreadsheet 1100 shows the date in column 1110 of an event of column 1160. Column 1120 provides the market price of GE shares. Column 1130 provides the price of the Rydex Venture 100 fund. Column 1140 provides the market price the Google shares. Column 1150 provides the market price of the Fidelity Select Natural Gas fund.

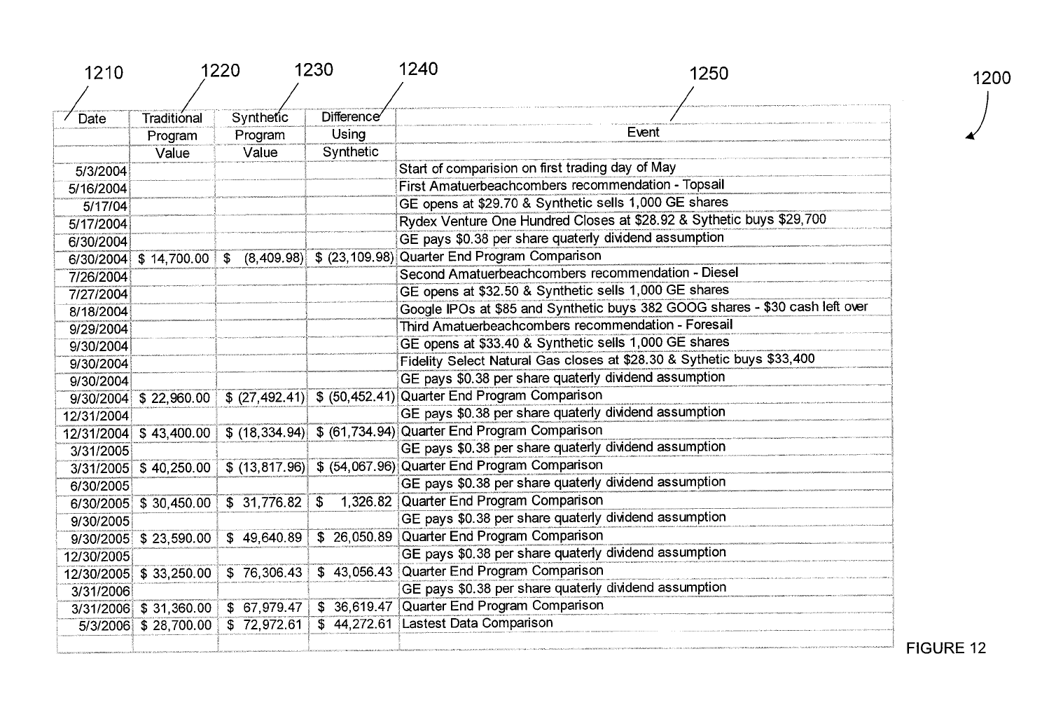

In a third example, the employee has been employed by GE and has been loaned seven thousand shares of the company's stock on May 3, 2004. The employee has been permitted to sell the GE shares and to purchase in a margin account stock at the recommendation of the AmateurBeachComber's newsletter using the sale's proceeds of the seven thousand loan shares. In this case, the results are set forth in FIGS. 12-15.

Referring to FIG. 12, spreadsheet 1200 provides a financial summary of the example of a loan of 7,000 GE shares deposited in a margin account to buy investments that were the investments recommended by a non-limiting exemplary newsletter such as “Amateurbeachcombers” using recommended dates and recommended prices.

In contrast to the second example presented in FIGS. 9-11, which uses the “buying power” or the credit that is extended by a stockbroker through a margin account based on the market value of the shares held in the margin account, the third non-limiting example allows that GE shares may be sold in order to use the cash proceeds from the sold shares to purchase new investments, in this case, the investment recommended by the newsletter. Therefore, in the third example, as opposed to in the second example, a cash account may be used to implement the synthetic option program instead of a margin account. Using the cash proceeds of loaned shares creates a “short position” to the employee as these loaned shares have to be repurchased in order to be repaid at the end of the loan pursuant to the selected features of the synthetic option program.

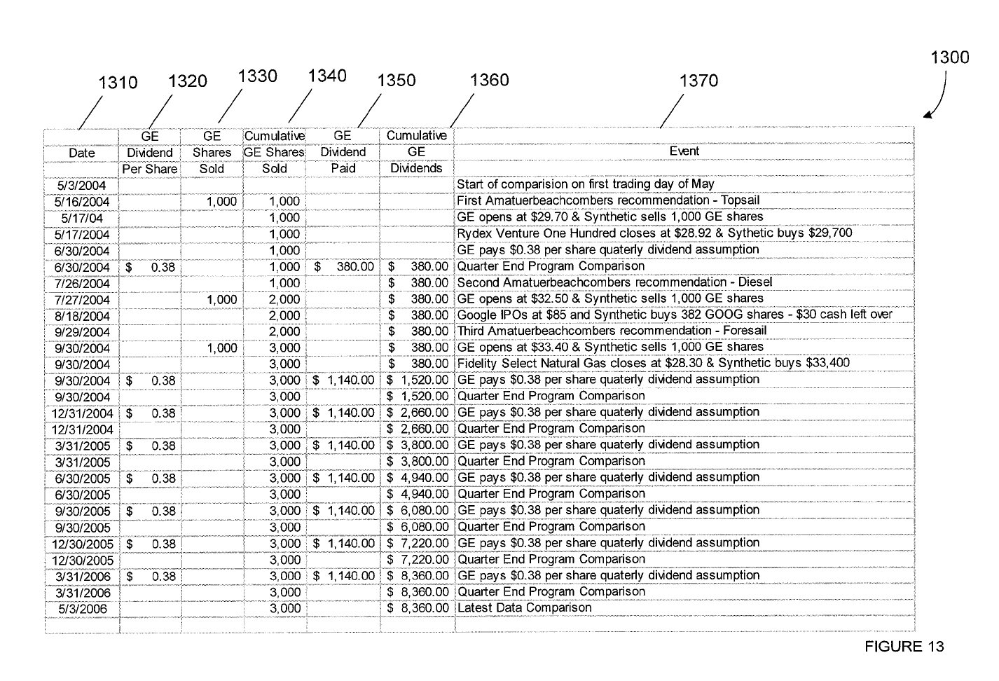

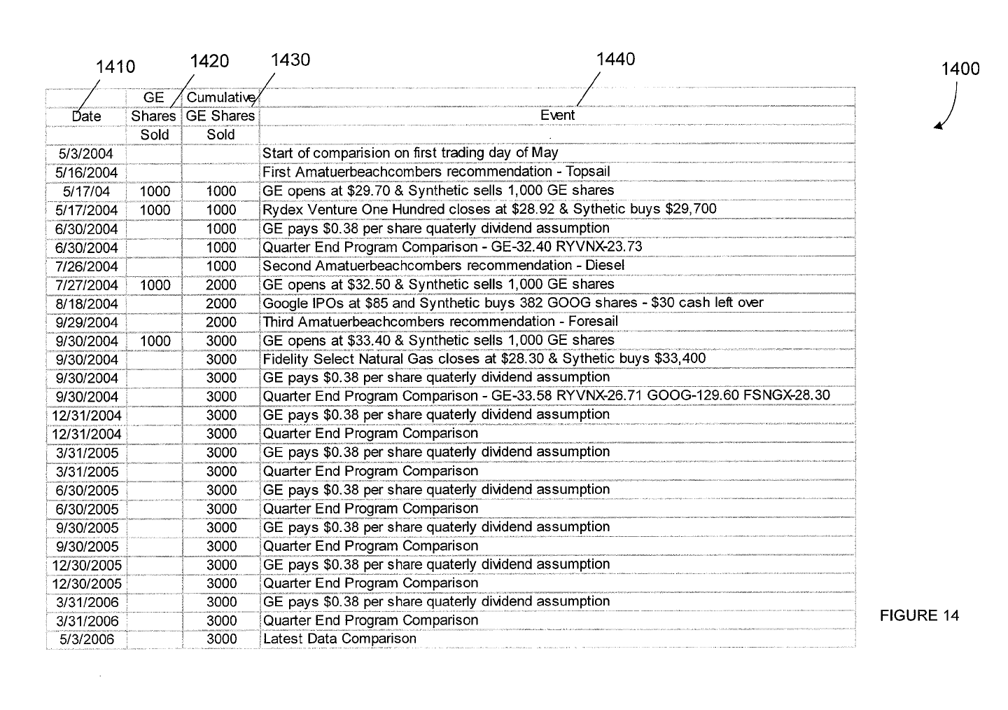

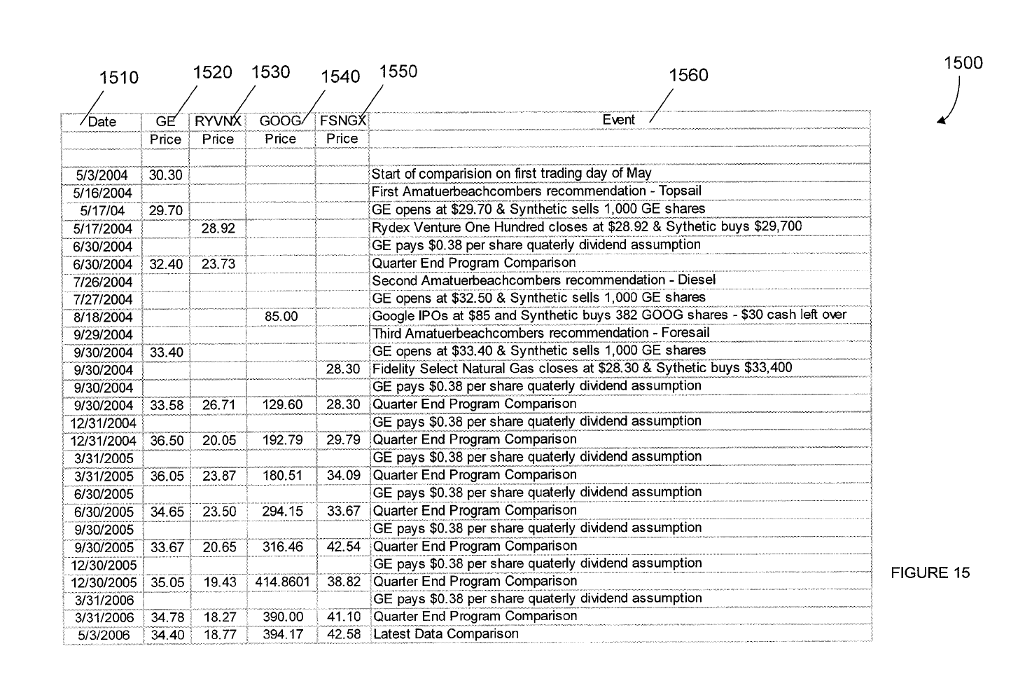

Spreadsheet 1200 provides the end result of this exemplary embodiment of a synthetic option program. Spreadsheet 1200 incorporates the results of data shown on the following spreadsheet 1300 of FIG. 13, spreadsheet 1400 of FIG. 14, and spreadsheet 1500 of FIG. 15. In this example, the synthetic option program uses the lending of GE shares and the sale of these loaned shares to generate cash for the funding of a purchase of other investments (in this example the other investments are two mutual funds, The Rydex Venture One Hundred, symbol “RYVNX” and Fidelity Select Natural Gas Fund, symbol “FSNGX” and Google, symbol “GOOG”).

For simplicity, this example only provides for the use of the buying power generated by the sale of 3,000 of the 7,000 GE shares loaned and deposited in the cash account, while it compares with the entire 7,000 shares being used in the traditional stock option program. Column 1220 of spreadsheet 1200 provides the value of a traditional employee stock option program with the option granted on 7,000 shares at the price of $30.30, the market price on May 3, 2004. The market price is provided in column 1520 of FIG. 15. Column 1230, entitled “Synthetic Program Value,” shows the value of the synthetic option program on the various dates shown in column 1210.

Column 1240, entitled “Difference Using Synthetic” shows the difference between the value of a tradition stock option program and the synthetic option program to the employee on the dates listed in Column 1210. The synthetic option program, valued at $72,972.61 on May 3, 2006, two years after the start of the program, is superior even using only three sevenths of the capital of the traditional stock option program. Additionally, the traditional stock option program would cost GE $28,700.00 in stock dilution costs while the synthetic option program would cost GE less than $100 in trustee fees. Moreover, the traditional stock option program would create taxable income for the employee, subject to the alternative minimum tax on taxable income of $28,700.00.

Referring to FIG. 13, spreadsheet 1300 tracks and calculates the amount of the GE dividend paid by GE on the shares sold. This represents an amount of cash that the employee owes GE and has to repay to GE. Column 1310 contains a date for an event of column 1370. Column 1320 is the GE dividend per share granted on a date of column 1310. Column 1330 represents shares of GE stock that are sold on dates of column 1310. Column 1340 tracks the cumulative number of shares of GE stock that have been sold. Column 1350 provides the amount of dividends paid by GE on the cumulative amount of stock as provided in column 1340. Column 1360 provides the cumulative amount of dividends paid by GE.

Referring to FIG. 14, spreadsheet 1400 tracks and calculates the number of the GE shares of stock that are sold to fund the purchases of the newsletter recommendation. Column 1410 provides a date for an event of column 1440. Column 1420 provides the amount of GE shares sold on a date of column 1410. Column 1430 provides the cumulative amount of GE shares sold as provided in column 1420.

Referring to FIG. 15, spreadsheet 1500 tracks the market prices of the GE shares and of the three different recommendations of the non-limiting example of the Amateurbeachcombers newsletter on the various dates provided in column 1510 for events of column 1560. Column 1520 provides the market price of GE shares. Column 1530 provides the price of the Rydex Venture 100 fund. Column 1540 provides the market price of the Google shares. Column 1550 provides the market price of the Fidelity Select Natural Gas fund.

By using the recommendations of the Amateurbeachcomber's newsletter, the employee may manage his non-cash employee compensation program with a relatively small time investment. The time investment would consist solely of checking a special email account for the purpose of receiving Amateurbeachcomber's trading alerts (or trading recommendations). This special purpose email account could be a free email account from Google, Yahoo, Microsoft Hotmail, or some other free email internet account that the employee does not use except for using it when registering to receive the Amateurbeachcomber's newsletter emails.

Embodiments of the present disclosure can be implemented in hardware, software, firmware, or a combination thereof. In the preferred embodiment(s), the method of non-cash employee compensation is implemented in software or firmware that is stored in a memory and that is executed by a suitable instruction execution system. If implemented in hardware, as in an alternative embodiment, the method of non-cash employee compensation can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Any process descriptions or blocks in flow charts should be understood as representing modules, segments, or portions of code which include one or more executable instructions for implementing specific logical functions or steps in the process, and alternate implementations are included within the scope of the preferred embodiment of the present disclosure in which functions may be executed out of order from that shown or discussed, including substantially concurrently or in reverse order, depending on the functionality involved, as would be understood by those reasonably skilled in the art of the present disclosure.

The non-cash employee compensation program, which comprises an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory. In addition, the scope of the present disclosure includes embodying the functionality of the preferred embodiments of the present disclosure in logic embodied in hardware or software-configured mediums.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

1. A method comprising:
selecting features of a stock option program of a company; and
granting an option to an employee through the stock option program to borrow at least one share of stock of the company.

2. The method of claim 1, further comprising:
directing management of the at least one share of borrowed stock of the company, the directing performed by the company.

3. The method of claim 2, wherein directing management of the borrowed shares comprises allowing an at-will sale of the at least one share of borrowed stock.

4. The method of claim 2, wherein directing management of the at least one share of borrowed stock comprises requiring any stock purchase based on the at least one share of borrowed stock to be purchased in a margin account.

5. The method of claim 4, further comprising requiring any stock purchase to be based on a recommendation in a financial industry newsletter.

6. The method of claim 2, wherein directing management of the at least one share of borrowed stock comprises restricting the use of the at least one share of borrowed stock to a purchase of at least one share of stock of the company.

7. The method of claim 2, wherein directing management of the at least one share of borrowed stock comprises allowing the use of the at least one share of borrowed shares as collateral for a loan to purchase a personal asset.

8. The method of claim 7, wherein the asset comprises a real estate asset.

9. The method of claim 8, further comprising restricting the use of the at least one share of borrowed stock for a real estate asset purchase to a joint purchase by the employee and a third party trustee.

10. The method of claim 9, further comprising directing a deposit for the purchase of the real estate asset to be purchased with record title held in the names of the employee and the third party trustee.

11. A computer readable storage medium comprising:
logic configured to select features of a stock option program of a company; and
logic configured to grant an option to an employee through the stock option program to borrow at least one share of stock of the company.

12. The computer readable storage medium of claim 11, further comprising:
logic configured to direct management of the at least one share of borrowed stock of the company.

13. The computer readable storage medium of claim 12, wherein logic configured to direct management of the at least one share of borrowed stock comprises logic configured to allow an at-will sale of at least one share of the borrowed stock.

14. The computer readable storage medium of claim 12, wherein logic configured to direct management of the at least one share of borrowed stock comprises logic configured to require any stock purchase based on the at least one share of borrowed stock to be purchased in a margin account.

15. The computer readable storage medium of claim 14, further comprising logic configured to require any stock purchase to be based on a recommendation in a financial industry newsletter.

16. The computer readable storage medium of claim 12, wherein logic configured to direct management of the at least one share of borrowed stock comprises logic configured to restrict the use of the at least one share of borrowed stock to a purchase of at least one share of stock of the company.

17. The computer readable storage medium of claim 12, wherein logic configured to direct management of the at least one share of borrowed stock comprises logic configured to allow the use of the at least one share of borrowed stock as collateral for a loan to purchase a personal asset.

18. The computer readable storage medium of claim 17, wherein the asset comprises a real estate asset.

19. The computer readable storage medium of claim 18, further comprising logic configured to restrict the use of the at least one share of borrowed stock for a real estate asset purchased with record title to be held jointly by the employee and a third party trustee.

20. The computer readable storage medium of claim 19, further comprising logic configured to direct a deposit for the purchase of the real estate asset purchased with record title held jointly in the names of the employee and the third party trustee.
